(19) United States
(12) Patent Application Publication
(10) Pub. No.: US 2004/0068515 A1
(43) Pub. Date: Apr. 8, 2004

(54) System for integrating a plurality of database systems with a plurality of graphics-based document systems for connecting data therebetween to enable a user at a computer-based user interface to access these systems in a unified manner

(76) Inventor: Keith Hallman, Arvada, CO (US)

Correspondence Address: PATTON BOGGS, PO BOX 270930, LOUISVILLE, CO, 80027, US

(21) Appl. No.: 10/264,877

(22) Filed: Oct. 4, 2002

(51) Int. Cl. G06F 7/00

(52) U.S. Cl. 707/102

(57) ABSTRACT

Integrating Application Programming Interface provides an application programming interface for use by commercial and non-commercial users and developers who wish to seamlessly integrate one or more database applications with one or more graphics-based document applications. Integrating Application Programming Interface is not dependent on any particular database application or any particular graphics-based document application. Instead, it creates a single user interface that addresses the common user activities related to integrating any graphics-based document application with any database application, and then provides a toolkit that can be used by any user or developer to integrate the data of any graphics application with the data of any database application.

### FIELD OF THE INVENTION

This invention relates to an application programming interface that seamlessly integrates database products with graphics-based document applications.

### PROBLEM

It is a problem in the software development industry for developers to seamlessly integrate their database products with graphics-based document applications. The database products are typically developed independent of the graphics-based document applications and the data that could be shared between these applications is not readily available for automated transfer between the applications. Typically, the data transfer between applications requires manual intervention and laborious efforts on the part of the user, with the associated increased risk of data entry errors.

A particular instance of this problem can be found in the construction or manufacturing industry where Computer Aided Design (CAD) systems are used to design a project. The Computer Aided Design system is a graphics-based document application which enables the designer to draw a project and specify the elements that are used to construct or manufacture the project. The Computer Aided Design system stores the design data for use in revising the design and generating the construction documents or “blueprints.”

In addition, there are separate project costing systems that are used to produce cost estimates for the construction or manufacturing of the projects that are designed. The project costing systems are database systems that use input data, consisting of a listing of the components required to construct or manufacture a project as well as component cost data, to generate a listing of the materials and labor costs for the various and specific systems of a project. In the estimating world, the input data is obtained from a set of construction documents, which are available in either paper form, or digital form. Regardless of the form of the construction documents, they share one important characteristic: they contain data that must be input into the project costing system. More specifically, the construction documents contain information about the building or manufacturing components to which the human (the estimator) must assign value (i.e., material and labor costs). Estimators generally maintain a master database of typical components, with various material and labor costs, which they can draw from as they develop a project cost. Project costing systems provide the ability to manage such a database. With a well-maintained master database, the majority of the input required from the user for a particular estimate consists of quantifying each component to be included in the project. Once all quantities have been entered for a project, the project costing system is used to assign material, labor and other related expenses, and to calculate the total cost for the project.

Many project costing systems address the data input issue by requiring a data input that is predicated on the use of either mechanical or electromechanical data input devices or the use of direct keyboard data entry of the quantity values. To accomplish the data entry task, estimators read blueprints and manually enter the quantity values into their project costing system, using either keyboards or electronic “counting probes” and “measuring wheels.” As the construction or manufacturing industry moves toward a paperless environment, estimators need to be able to “read” digital documents rather than just paper-based blueprints.

Computer Aided Design documents are becoming more and more object-based, rather than just being a digital collection of interconnected arcs and lines. Technically, this means that software can be programmed to “read” a digital version of a construction document, recognize objects as distinct project components, and quantify (count and/or measure) the project components faster than humans do manually.

However, over the years, Computer Aided Design systems and project costing systems have evolved independently—meaning that no single software application has emerged that meets the needs of both the designer and the estimator. This is understandable because estimators generally don't need to do design, and designers generally don't need to perform project costing. However, there is still a need for the data to be shared between these applications to complete a construction project.

### SOLUTION

The application programming interface for integrating database products with graphics-based document applications (termed “Integrating Application Programming Interface” herein) seamlessly integrates database products with graphics-based document applications. The Integrating Application Programming Interface is not dependent on any particular database product or graphics-based document application. Instead, it creates a single user interface that addresses the common user activities related to integrating any graphics-based document application with any database product, and then provides a developer's toolkit that can be used by the vendors of these systems to integrate the other system's functionality into their respective products.

The Integrating Application Programming Interface implements a user interface that accommodates all of the various tasks related to quantification, identification, classification, etc. of the components, resident in the graphics document, and associated with a particular project. In addition, the Integrating Application Programming Interface isolates the database product developer from the proprietary data structures and the development constraints of each supported graphics application. The Integrating Application Programming Interface includes two major components: a user interface, and a developer's toolkit. In the above-noted example of the construction or manufacturing industry, where the user is interfacing a Computer Aided Design based system with a project costing system, the user interface is typically implemented as an ActiveX Control. An ActiveX Control is a user interface component that can be inserted into other software applications, such as a Computer Aided Design system. The developer's toolkit is a set of programmable objects that can be used to “plug-in” a specific Computer Aided Design system and a specific project costing system into the Integrating Application Programming Interface. Thus, the two systems are linked together via the single user interface, with the plug-in modules providing the communication channel between the systems.

Microsoft's Component Object Model technology (COM) allows applications to communicate without dependency on the specific programming language used to create each application. The Integrating Application Programming Interface uses tools such as Component Object Model technology to seamlessly link the graphics and database environments, accomplishing communications in real-time rather than as an historical event, as done with traditional import/export mechanisms. The key mechanism of the Component Object Model is the use of interfaces, or collections of related methods that define rules about how an application communicates with another application or object. The calling object doesn't know or care how the interface is implemented, but only that a particular functionality can be obtained when using a specific object that supports a specific interface. Similarly, the called object does not know the identity of the calling object or the use for which the data is destined, but simply performs the requested function and outputs the associated data through the selected interface.

### BRIEF DESCRIPTION OF THE DRAWINGS

FIG. 1 illustrates in block diagram form the overall architecture of the Integrating Application Programming Interface-and a typical application thereof;

FIG. 2 illustrates in block diagram form the components of a typical takeoff user interface that provides a tree-style interface to allow the user to interact with the various objects related to takeoff activity; and

FIG. 3 illustrates a tree-style interface used to implement a typical takeoff user interface.

### DETAILED DESCRIPTION

It is a problem in the data processing industry for developers to seamlessly integrate their database products with graphics-based document applications. The database products are typically developed independent of the graphics-based document applications and the data that must be shared between these applications is not readily available for automated transfer between the applications. Typically, the data transfer between applications requires manual intervention and laborious efforts on the part of the user, with the associated increased risk of data entry errors.

Construction Industry Example—Background

A particular instance of this problem can be found in the construction industry where a Computer Aided Design (CAD) system is used to design a project. The Computer Aided Design system is a graphics-based document application that enables the designer to draw a project and specify the elements that are used to construct the project. The Computer Aided Design system stores this data for use in revising the design and generating blueprints.

In addition, there are separate project costing systems that are used to produce cost estimates for the construction of the projects. The project costing systems are database systems that use input data, consisting of a listing of the components required to build a project, as well as component cost data, to generate a listing of the materials and labor costs for a project. The data input is predicated on the use of either mechanical or electromechanical data input devices or the use of direct keyboard data entry of the quantity values. To accomplish the data entry task, estimators read blueprints and manually enter the quantity values into their project costing system, using either keyboards or electronic “counting probes” and “measuring wheels.”

Common Functionality

In the above-noted example, the user activities related to sharing data from a Computer Aided Design document with a project costing application are summarized in the following categories:

Project/Document Management

Takeoff Assignment

Takeoff Quantification

Takeoff Viewing and Querying

These activities are described below. For purposes of this document, the term “takeoff” is used to describe the end result of the quantification of a given project, and not the act of quantification itself.

Project/Document Management—This activity includes all of the pre-takeoff activities, such as logging into the system, creating or choosing a project to work with, and identifying any additional drill-down into that project into specific categories such as a project, phase, a particular subsystem, and the like. It also includes setting up user preferences, such as units, labor factors, and so on.

Takeoff Quantification—This activity includes tallying and measuring objects in the digital construction document in order to accurately assign quantities of project components to the master cost database.

Takeoff Assignment—This activity includes assigning quantified objects to specific components in the cost database.

Takeoff Viewing and Querying—This activity leverages the display capability of the graphic software application by allowing the user to view and query takeoff information from within the graphics environment.

Integrating Application Programming Interface System—Components Description of System Components

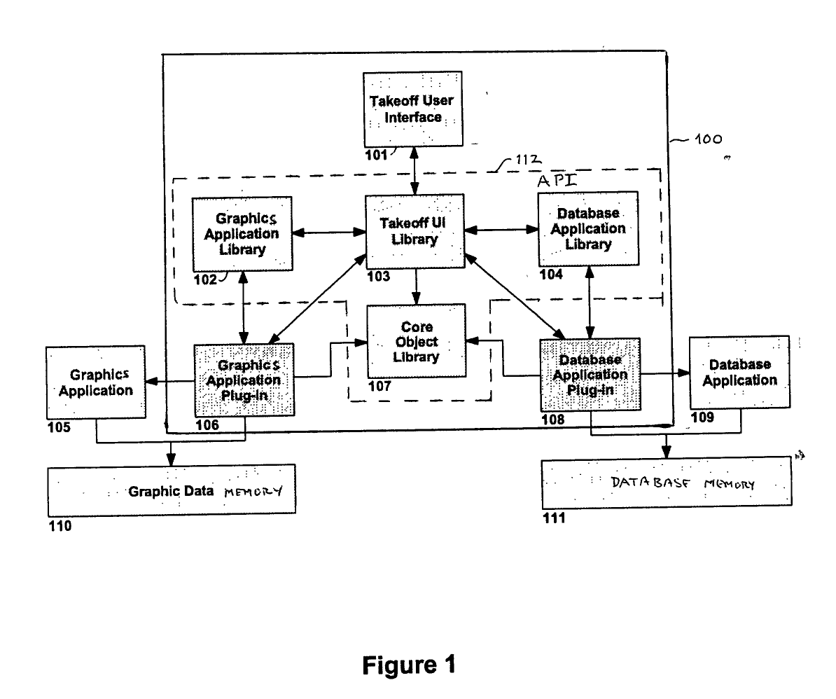

FIG. 1 illustrates in block diagram form the overall architecture of the Integrating, Application Programming Interface 100 and a typical application thereof. In this example, the Graphics-Based Document Application 105 is connected to the Database Application 109 via the Integrating Application Programming Interface 100. The Integrating Application Programming Interface 100 includes a Takeoff User Interface 101, API 112, Graphic Application Plug-In 106, and a Database Application Plug-In 108. These elements and their respective-functions are described below.

The integration of the Graphics-Based Document Application 105 and the integration of the Database Application 109 with the Integrating Application Programming Interface 100 are effected in an equivalent manner. In other words, the Integrating Application Programming Interface 100 uses the same techniques for integrating both of these applications.

Graphics-Based Document Application 105—This element represents the source of the digital design data (graphics-based data), which data is shown as residing in a Graphics Data Memory 110. There are numerous digital design model formats that can be used for the Graphics-Based Document Application 105, but these options are not discussed herein in the interest of simplicity of description, since their use would be analogous to that described for the construction example implementation of the Graphics-Based Document Application 105 using a CAD-based system.

Takeoff User Interface 101—This element represents the primary user interface for the Integrating Application Programming Interface 100. The central component to this Takeoff User Interface 101 is the Takeoff Manager Window 101A that comprises the command center for all graphics-based document application takeoff activity. The Takeoff User Interface 101 implements those parts of the total User Interface that are not dependent on any particular Graphics-Based Document Application 105 or any particular Database Application 109. The complete User Interface, as the term is used herein, consists of all the components (Graphics-Based Document Application 105, Takeoff User Interface 101, API 112, Graphics Application Plug-in 106, Database Application Plug-In 108, and Database Application 109) working together. The Takeoff User Interface 101 is most commonly implemented as an ActiveX control (OCX), which is presented to the user.

The Takeoff User Interface 101 typically has two main components. The first is the Takeoff Manager Window, which is the command center for all takeoff activity within the graphic environment. It is where the user manages all of the tasks related to takeoff activity. The second component is termed the Component Manager, and it provides the user with access to the Database Memory 111, from within the graphics environment. Together, these two components provide the user with the basic, common tools needed to perform takeoff activity in, for example, a digital construction document. Each of these two components consists of a hierarchical tree-view representation, and an associated properties list. When a node in the tree-view is selected, the properties or attributes associated with that node are displayed in the properties list. Each node can support a shortcut menu that allows the user to easily invoke specific tasks related to the object represented by the node. This style of user interface is consistent with that of other software applications, thus reducing the amount of training needed for the product. These two components, which make up what is termed the Takeoff User Interface 101, are most commonly implemented as ActiveX Controls, so that they can easily be hosted by (inserted into) other software applications, such as a CAD application. This gives the user the impression that the Takeoff Manager Window and the Component Manager are seamlessly integrated, or are a part of their graphics application. ActiveX Controls are themselves Component Object Model (COM) servers, and can therefore be programmatically controlled (the server can expose functions which can be used by another application to control the server with code).

An important concept of the Takeoff User Interface 101 is that it provides a single, consistent interface, regardless of which graphics application or which database application is being used. For example, in the construction example noted above, the User Interface is not of much use to an estimator by itself. It relies on the existence of a provider of digital construction documents (the graphics application), and a provider of cost-based data (the database application). The User Interface acts as a bridge between the graphics application and the database application.

API

The API 112 is a library of programmable objects (COM Objects) that allow both graphics applications and database applications to integrate themselves with the central Takeoff User Interface 101. The objects that are included in the API 112 can be broken down into two categories: 1) objects that are related to takeoff activity, such as projects, graphic documents, and components, and 2) objects that represent pieces of the user interface, such as the Takeoff Manager Window, nodes in the tree-view, properties in the properties list, a menu or menu item.

The first set of objects, those that represent real-world or takeoff-related objects is contained within the Core Object Library 107. These objects provide a common language that the Graphics Application 105 and the Database Application 109 can use to communicate with each other. The Takeoff User Interface objects are contained within the Takeoff User Interface Library 103. These objects give developers of both the Graphics Application 105 and the Database Application 109 the ability to customize the behavior of the Takeoff User Interface 101 in order to accommodate their own specific features, functionality, or needs. For example, the API 112 provides the ability for these applications to completely define the behavior of the various nodes in the tree-view, including the text that is displayed, any visual aids that are presented, the items in the short-cut menu, and the properties that are displayed.

The objects in the API 112 support COM functionality such as Properties, Methods, and Events. For example, the Graphic Document object includes properties, such as the location of the file and the date that the graphic document was last saved. It includes methods, such as Open, Close, and Save, and Activate. It also includes Events, such as when a graphic document is made current, or when a Takeoff Group (described below) has been created. Events allow other applications (the Graphic Application 105 and the Database Application 109) to respond (execute their own code) when these events occur.

The objects in the Takeoff User Interface 101 also include methods, properties, and events. For example, the TreeNode object includes properties, such as the text, icon, and the shortcut menu. It includes events, such as when the user clicks on the node, or when the menu is about to be displayed, or when a child node is added or deleted.

Modifying properties, invoking methods, and responding to events are what provide the real-time (or live) connection between the Graphics Application 105, and the Database Application 109. A single user action (such as something as simple as a mouse click on the tree) could result in the execution of code in all three applications (the Takeoff User Interface 101, the Graphics Application 105, and the Database Application 109). Providing programmable objects for the components of the Takeoff User Interface 101 allows the Takeoff User Interface 101 to maintain a consistent look and feel, while allowing both the Graphics Application 105 and the Database Application 109 to integrate their own custom functionality. For example, the contents and behavior of the Component Manager are defined largely by the Database Application 109. The Takeoff User Interface 101 provides an “empty” tree, in which the Database Application 109 can display its component database, stored in Database Memory 111 in a hierarchical fashion. This approach enables the user to view the entire contents of the component database from within the Takeoff User Interface 101. This represents just one way for the user to access this information. The user can still view and manipulate the component database from within the Database Application 109.

Another concept that is leveraged in the API 112 is the use of, (in COM terms), “Interfaces.” As stated earlier, the Takeoff User Interface 101 uses exactly the same techniques for integrating the Graphics Application 105 and the Database Application 109. The fundamental technology behind this technique is COM, or more specifically, COM interfaces. The API 112 defines a set of COM interfaces that it expects the Graphics Application Plug-In 106 to implement, and it defines a set of COM interfaces that it expects the Database Application Plug-In 108 to implement. Each plug-in can then use what ever means necessary to communicate with its respective application and/or data.

The API is divided into four components (COM Libraries):

1. 102 Graphics Application Library—Contains the interfaces and objects that support the communication between the Takeoff User Interface 101 and the Graphics Application 105.

2. 104 Database Application Library—Contains the interfaces and objects that support the communication between the Takeoff User Interface 101 and the Database Application 109. This element represents a type library (TLB) that defines the interfaces used by the Takeoff User Interface 101 to communicate with the Database Application Plug-In 108. It is strictly an interface specification; it contains no implementation, and therefore, no executable code.

3. 103 Takeoff User Interface Library—Contains the interfaces and objects that are used (by both the Graphics Application 105 and the Database Application 109) to control and customize the various parts of the central Takeoff User Interface 101.

4. 107 Core Object Library—Contains the interfaces and objects that represent “takeoff activity” objects, such as Projects, Graphic Documents, and Components. This element represents the central Component Object Model server for the system. It is an object model that encapsulates the data structures and business rules or behavior that are common across the entire system. The Core Object Library 107 component by itself has no dependencies on any other system or application. It is referenced by and known to the Takeoff User Interface 101, Database Application Library 104, and Database Application Plug-In 108.

A benefit of this structure is to create an interface that incorporates all of the common functionality related to performing takeoffs for the purpose of integrating data into a graphics environment, and then exposing an API that allows ANY graphics application to act as the provider of graphics information, and ANY database application to be the provider of fiscal data.

Object Selection Filters

Another important concept is that of Selection Filters. Selection Filters are rules that can be applied to a digital construction document to extract a specific subset of objects for the purpose of quantification. The primary reason that an estimator, for example, would use a digital document is to leverage the data already built into the document. The more object-based the digital document is, the more data that can be extracted.

Every graphics application (and thus, every digital document format) has a different set of properties or characteristics that are used to describe graphic objects. For example, in the commercially available AutoCAD product, all objects have a set of common properties, such as Object Type, Layer, and Color. Each object type also has additional properties that can be filtered.

In order to maintain independence from any specific graphics application, the Integrating Application Programming Interface 100 treats selection filters as a very generic concept. It does this by making two simple assumptions. The first assumption is that every graphics document is made up of objects. Even in the non object-based environment of raster data, there are ways to identify and markup “objects” in the document, the objects in this case being the mark-ups rather than the actual rasters. The second assumption is that each object has at least one property that can be used to identify it. By definition, every- object has an identity (the simple fact that it exists) and at a bare minimum, the identity itself can be considered a property. Beyond that, defining what properties can be used to filter objects, and how the user acquires objects using those properties is the responsibility of the graphics application Plug-in 106. The API 112 contains COM interfaces that are implemented by the graphics application plug-in to define these selection filters. When the user builds a selection set of objects to be quantified, the Takeoff User Interface 101 is able to call on the graphics application to provide the user tools to carry out that action.

Takeoff Groups

Another innovative concept is the Takeoff Group. A Takeoff Group is defined as a set of objects that have been quantified and assigned to one or more components in the database. The concept of selection filters allows a rules-based approach to breaking down a digital document into logical groups of objects. Each takeoff group contains the set of rules that define which objects are contained within it, along with the list of components that are to be assigned to those objects.

An estimator may receive several digital documents from the same author. If the estimator wishes to define a set of rules (Takeoff Groups) that apply to one digital document, then that same set of rules could be applied to multiple similar documents, reducing the amount of time needed to acquire takeoffs.

Database Application Plug-in—This element represents a “plug-in”, which is generally provided by the vendor who markets the Database Application 109, although it can be implemented by the developer who implements the Integrating Application Programming Interface 100. This Database Application Plug-In 108 is implemented as a Component Object Model server (DLL), which implements the interfaces defined in the Database Application Library 104. The Database Application Plug-In 108 uses whatever means necessary to communicate with its associated Database Application 109 and Database Memory 111. The location of the Database Application Plug-In 108 is a matter of design choice, and can either be part of the Integrating Application Programming Interface 100 or located within the Database Application 109. In either case, it is functionally a component of the Integrating Application Programming Interface 100 as this term is used to describe the method of seamlessly integrating a database product with a graphics-based document application.

Database Application Data—This element, located within the Database Memory 111 represents the Database Application that is selected to execute in this environment and its associated database. The Database is typically specific in its implementation to a particular Database Application 109 and thus, the Database Application Plug-In 108 is adapted to seamlessly interface with the Database.

### Distinguishing Characteristics

What makes the Integrating Application Programming Interface 100 unique is that it is not dependent on any particular Graphics-Based Document Application 105 (such as a CAD-based application) or a Database Application 109 (such as a project costing application). Instead, it creates a single user interface that addresses the common user activities related to integrating any database system with any graphic system, and then provides a developer's toolkit that can be used by developers of these systems to integrate the other system's functionality into their products. From a technical point of view, the use of Component Object Model technology is the most logical choice given the present state of the technology, and the need to provide interoperability between applications. The Integrating Application Programming Interface 100 does two main things in terms of its approach to solving the problem at hand: 1) it gives the user a comprehensive set of tools to perform quantification and management of takeoff activity in a graphical environment, and 2) rather than being written for a specific graphic environment or database application, the Integrating Application Programming Interface 100 focuses on the act of linking data and graphics (project costing is one mainstream example of this benefit), and bringing both together into a single user interface.

An important end result is that the limitations imposed by the data structure in the database and graphics applications are bypassed. The present description of Integrating Application Programming Interface 100 includes, by way of example, the world's most abundant graphic document data, that of AutoCAD by Autodesk, Inc., but is not limited to this application and can accommodate additional vector and raster formats.

This Integrating Application Programming Interface 100 provides an application programming interface for use by developers who wish to seamlessly integrate their database products with graphics-based document applications. Using Integrating Application Programming Interface 100, the database product developer can create a live graphics-to-database communication channel with substantially less effort than other methods.

Component Object Model (COM) is one current technology which allows applications to communicate without dependency on the specific programming language used to create each application. Integrating Application Programming Interface 100 uses tools such as Component Object Model technology to seamlessly link the graphics and database environments, accomplishing communications in real-time rather than as an historical event like an import/export mechanism would.

The key mechanism of COM is interfaces, or collections of related methods defining rules about how an application communicates with another application or object. The calling object doesn't know or care how the interface is implemented, but only that a particular functionality can be obtained when using a specific object that supports a specific interface.

The Integrating Application Programming Interface 100 carries with it a proven user interface that accommodates all of the various tasks related to quantification, identification, classification, etc. of the graphics document. In addition, the Integrating Application Programming Interface 100 isolates the database product developer from the proprietary data structures and development constraints of each supported graphics application.

### How the Integrating Application Programming Interface Works

The Integrating Application Programming Interface 100 consists of two major functional components: a user interface, and a developer's toolkit. The user interface is implemented as one or more ActiveX Controls. An ActiveX Control is a user interface component that can be inserted into other software applications, such as a Computer Aided Design application. The developer's toolkit is a set of programmable objects that can be used to “plug-in” a specific Graphics-Based Document Application 105 and a Database Application 109.

Takeoff User Interface

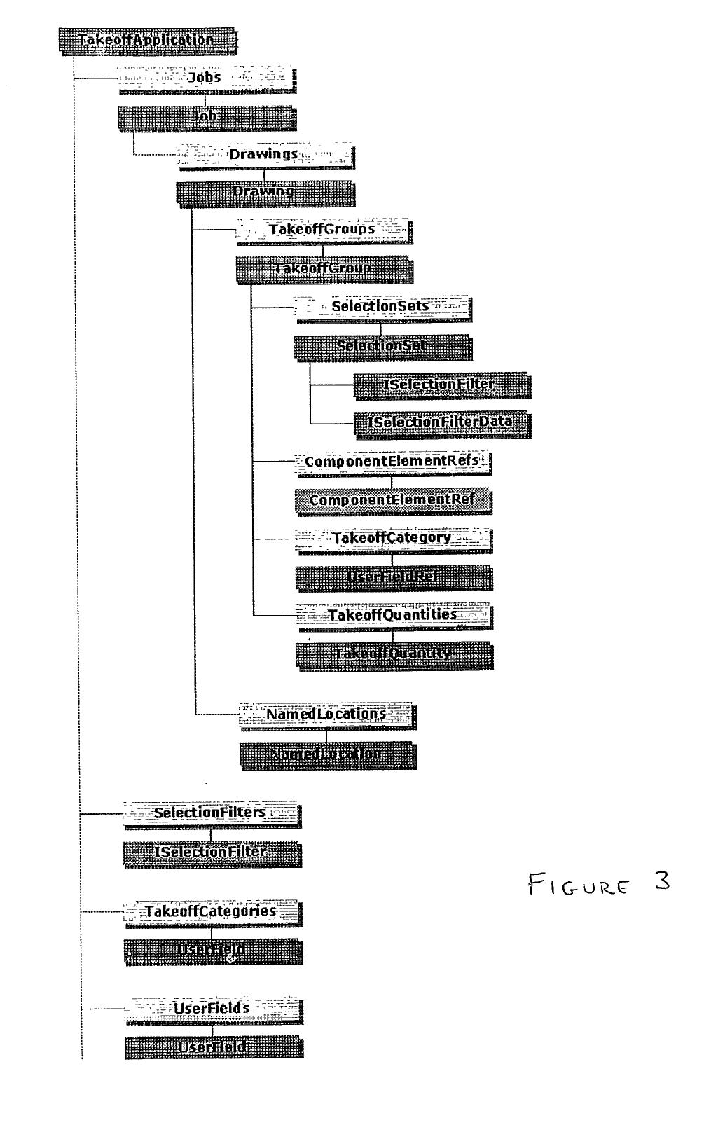

Several components of the Takeoff User Interface 101 provide a hierarchical, tree-style-interface, as illustrated in FIG. 3, to allow the user to interact with the various objects related to takeoff activity. Each node in a tree typically represents an object in an Application Programming Interface, in the case of the construction example noted above, the first level of the hierarchy for a Graphics Application Plug-in 106 would typically include: Projects, Selection Filters, Takeoff Categories and User Fields. Each of the nodes on each level can have multiple additional levels, with each level having one or more additional nodes. For example, in a Projects node, this would break into a plurality of elements that define a Project, such as: Graphic Documents. The Graphic Documents node would expand into such elements as Named Locations and Takeoff Groups. The Takeoff Groups relate to the various construction or manufacturing elements that comprise a particular set of graphic documents and are divided into the nodes: Selection Sets, Component Elements, Takeoff Category, and Takeoff Quantities. Thus, a construction or manufacturing project, using this example of the Graphics-Based Document Application 105 which uses a CAD system to generate the data that is stored in memory 110, can be processed by a Database Application 109, such as a project costing system. The various pieces of data that are typically passed between these systems are delineated by the various nodes in the hierarchy illustrated in FIG. 3.

A plug-in can optionally define objects that provide custom behavior that is associated with the nodes in a tree, such as text, icon, and shortcut menus. As the application builds each node in a tree view, it queries the plug-in for a custom handler object for that node through an interface. Each tree-view is accompanied by a properties list, which is used to display custom properties for the presently selected node in the tree. The properties list is populated from a collection of User Field objects provided by the plug-in. The plug-in has complete control of the visibility, editablility, and behavior of each object.

Take-Off User Interface Implementation

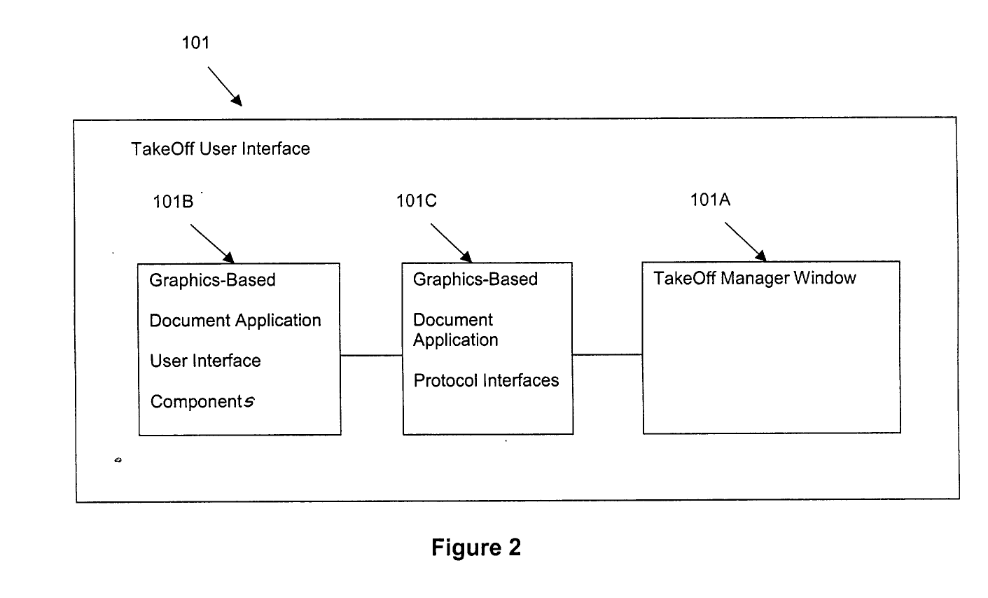

The Take-Off User Interface 101, as described above, can be implemented in many ways. As shown in FIG. 2, the Take-Off User Interface 101 can be implemented via the use of a plurality of elements. As noted above, the Takeoff Manager Window 101A comprises the command center for all graphics-based document application takeoff activity. In addition, the Graphics-Based Document Application User Interface Component 101B represents the component that provides the direct Graphics-Based Document Application functionality.

For example, the functions that are typically implemented in this environment of a construction or manufacturing application are: selecting objects, quantifying objects, attaching data to objects, and filtering objects based on specific object properties (such as the unique name of a graphic symbol). The Graphics-Based Document Application User Interface Component 101 B acts as a Component Object Model client to Graphics-Based Document Application 105 (such as a CAD system) using the Graphics-Based Document Application object models, which in this example would be CAD object models. It also acts as a Component Object Model server for the Takeoff User Interface 101 by implementing a series of interfaces defined in the Database Application Library 104.

The Graphics-Based Document Application User Interface Component 101B can be implemented as a series of components, one for each distinct Graphics-Based Document Application 105 that the Integrating Application Programming Interface system 100 supports. The Graphics-Based Document Application Protocol Interfaces 101C represents a library of interfaces and objects used by the Takeoff User Interface 101 to communicate with the Graphics-Based Document Application User Interface Components 101B.

How seamless the Takeoff User Interface 101 appears to the user is dependent on how well the Graphics Application 105 can “host” the Takeoff User Interface components. The above-noted AutoCAD product, for example, provides the ability to “host” User Interface components as dockable controls in the AutoCAD frame window. This gives the AutoCAD user a great deal of comfort when working with this interface, because it looks and feels like a part of AutoCAD. The use of ActiveX Control (OCX) technology for the Takeoff User Interface 101 provides an excellent method to integrate an interface in a similar way in other graphic applications. However, not many databases come with an (ActiveX/COM) interface. What they do come with (or a third party may provide) is either an ODBC or OLE DB “driver” which is a standard DLL (not a COM DLL). If such a driver is available, a developer can use ADO (ActiveX Data Objects) to “talk” to the database from an application. ADO is a COM library that communicates with OLE DB drivers. ADO is like a COM “wrapper” for OLE DB. The ADO library is included with the Microsoft Windows operating system.

To diagram how an application communicates with a database using ADO:

App←→ADO←→OLE DB Driver←→Database

For databases that only have an ODBC driver, the operating system includes an “OLE DB Driver for ODBC”. This means that applications can communicate with any ODBC-compliant database in exactly the same way:

App←43 ADO←→OLE DB Driver←→ODBC←→Database

The Integrating Application Programming Interface 100 puts yet another communication layer between CAD and the database. Therefore, the Integrating Application Programming Interface 100 insulates the Database Application 109 from having to communicate directly with the Graphics Application 105 and, in the same manner, the Database Application Plug-in 108 insulates the Integrating Application Programming Interface 100 from having to communicate directly with the Database Application 109. Fundamentally, the Database Application Plug-in 108 must be a COM server (DLL), which implements the interfaces defined in the Integrating Application Programming Interface 100. COM defines a standard way for applications to expose their functionality to other applications.

### Developer's Toolkit

The developer's toolkit, stored in the Core Object Library 107 is based on Component Object Model technology. Three important concepts in COM fundamental to understanding how Integrating Application Programming Interface works are Interfaces, Classes, and Objects.

Interface—A Component Object Model Interface is simply a specification that describes how to access a set of functions. Interfaces contain no executable code —they just describe a set of function signatures.

Class—A Component Object Model Class contains the implementation (code) for one or more interfaces.

Object—An object is an instance of a class, which is created while the program is running.

The Integrating Application Programming Interface developer's toolkit includes many interfaces. The toolkit also includes classes that implement many of those interfaces. Some of the interfaces define functionality that is needed in an external application (such as a project costing program) and it is the responsibility of that external application to provide the classes that implement those interfaces.

For example, project costing applications maintain a list of projects that the user has created in the costing application, along with a way for users to choose which project they are about to perform work in. The Integrating Application Programming Interface user interface needs to get access to this information, but has no idea how the projects are stored or how to activate a specific project, so the toolkit defines an interface called IJobInfo. The IJobInfo interface contains two function signatures, GetJobList and SetActiveJob. The toolkit does not, however, provide a class that implements this interface. The external project costing program, Database Application plug-in 108, is responsible for providing the class—and thus providing the code that actually does the work of getting the list of projects and performing whatever action is necessary when the user activates a project. This paradigm is used throughout the Integrating Application Programming Interface 100 to integrate the two applications.

The toolkit defines two distinct interface libraries stored in the API 112; one that defines interfaces to be implemented by the Graphics-Based Document Application 105 (such as a CAD application), and one that defines interfaces to be implemented by the Database Application 109 (such as a project costing application). The toolkit also provides a library of classes (called the Core Object Library 107) that represent the fundamental data structures related to user activity that are shared between the applications, such as projects, graphic documents, cost components, takeoff groups, and so on. The Core Object Library 107 could therefore be considered the “backbone” of the system—it is used by all components of the system.

Summary

The Integrating Application Programming Interface, as described above, creates a single user interface that addresses the common user activities related to integrating any graphics-based document application with any database application, and then provides a toolkit that can be used by developers of these systems to integrate the other system's functionality into their products.

What is claimed:

1. An integrating application programming interface connected to and interconnecting a graphics-based document system with a selected one of a plurality of database systems comprising:
API library means for storing at least one set of graphics interface data, each of which defines an interface to be implemented by said graphics-based document system, and a plurality of sets of database interface data, each of which defines an interface to be implemented by one of said plurality of database systems;
at least one graphics application plug-in means, connected to said API library means, each of which uses at least one of said at least one set of graphics interface data to communicate with said graphics based document system;
at least one database application plug-in means, connected to said API library means, each of which uses at least one of said plurality of sets of database interface data to communicate with a corresponding one of said plurality of database systems; and
takeoff user interface means, connected to said API library means, for providing a user with a single interface to operate said graphics-based document system in conjunction with a selected one of said plurality of said database plug-in means with said associated database system.

2. The integrating application programming interface of claim 1 wherein said API library means comprises:
graphics application interface library means for storing data for use by said takeoff user interface means to communicate with said at least one graphics application plug-in means.

3. The integrating application programming interface of claim 1 wherein said API library means comprises:
database application interface library means for storing data for use by said takeoff user interface means to communicate with said selected one of one of said plurality of said database application plug-in means.

4. The integrating application programming interface of claim 1 wherein said API library means comprises:
core object library means for providing a library of the interfaces and objects that represent the fundamental data structures related to user activity that are shared between said graphics-based document system with a selected one of said plurality of database systems.

5. The integrating application programming interface of claim 1 wherein said API library means further comprises:
takeoff user interface library means for providing a library of the interfaces and objects that are used between said graphics-based document system and said plurality of database systems to control and customize the various parts of said takeoff user interface means.

6. The integrating application programming interface of claim 1 wherein said core object library means comprises:
developer's toolkit means for storing a plurality of specifications, each of which describes how to access a set of functions in said plurality of database applications, and an implementation for each of said plurality of specifications.

7. The integrating application programming interface of claim 6 wherein said core object library means further comprises:
component object model server or other means for encapsulating the data structures and behavior rules that are common across the entire system.

8. The integrating application programming interface of claim 1 wherein said takeoff user interface means comprises:
user graphics system interface means for providing the direct graphics-based document application functionality.

9. The integrating application programming interface of claim 8 wherein said user graphics system interface means implements at least one of the functions: selecting objects, quantifying objects, marking or identifying objects as quantified, attaching data to objects, and filtering objects based on specific object properties.

10. The integrating application programming interface of claim 1 wherein said core object library means comprises:
filter selection means for implementing a plurality of rules that can be applied to a graphics-based document, stored in said integrating application programming interface, to extract a specific subset of objects from said graphics-based document for the purpose of quantification of said objects.

11. The integrating application programming interface of claim 10 wherein said core object library means further comprises:
takeoff group means for implementing a set of rules comprising said rules applied to a selected set of said objects, said set of rules defining which objects are contained within it, along with the list of components that are to be mapped to those objects.
